(19) United States
(12) Patent Application Publication
(10) Pub. No.: US 2026/0119027 A1
(43) Pub. Date: Apr. 30, 2026

(54) OPERATION PROCESSING METHOD, ELECTRONIC DEVICE, AND STORAGE MEDIUM

(71) Applicant: Lenovo (Beijing) Limited, Beijing (CN)

(72) Inventors: Difei ZHANG, Beijing (CN); Meng WU, Beijing (CN); Yu ZHANG, Beijing (CN)

(21) Appl. No.: 19/365,639

(22) Filed: Oct. 22, 2025

(30) Foreign Application Priority Data
Oct. 29, 2024 (CN) 202411521448.8

(51) Int. Cl. G06F 3/0486; G06F 3/04842; G06F 9/451; G06F 40/103; G06F 40/166; G06F 40/40; G06T 7/70; G06V 30/413

(52) U.S. Cl. CPC G06F 3/0486; G06F 3/04842; G06F 9/451; G06F 40/40; G06T 7/70; G06F 40/103; G06F 40/166; G06V 30/413

(57) ABSTRACT

An operation processing method includes, in response to detecting a location change event for a first object, using a first intelligent agent to identify object information of the first object and application information of an application where the first object is located before and after the location change event respectively; based on the object information of the first object and the application information of the application where the first object is located before and after the location change event respectively, determining a processing intent for the first object, and obtaining a confirmed result of processing intent; using the first intelligent agent to determine target processing to be performed on the first object, based on the confirmed result of processing intent; and using a second intelligent agent to perform the target processing on the first object after the location change event, to obtain a processing result of the first object.

### CROSS-REFERENCES TO RELATED APPLICATIONS

The present disclosure claims priority of Chinese Patent Application No. 202411521448.8, filed on Oct. 29, 2024, the entire content of which is hereby incorporated by reference.

### FIELD OF THE DISCLOSURE

The present disclosure generally relates to the field of human-computer interaction and artificial intelligence technology and, more particularly, relates to an operation processing method and an operation processing device.

### BACKGROUND

In daily use of electronic devices for learning or work, there may be operational scenarios where a user needs to perform an operation across different applications, or perform related operations in different parts of a same application. In existing technologies, such operational scenarios may not be user-friendly, and may have problems such as complicated user operations, low efficiency, and long processing time. For example, in scenarios involving operations across different applications, copying a table from Excel to PowerPoint may require additional time to adjust the format. When performing copy and paste operations within a same application, a user may need to adjust the size, format, etc. of the pasted text or other objects after the text or other objects are pasted to the target location. As such, the user experience may be negatively impacted.

### SUMMARY

One aspect of the present disclosure provides an operation processing method. The method includes, in response to detecting a location change event for a first object, using a first intelligent agent to identify object information of the first object and application information of an application where the first object is located before and after the location change event respectively; based on the object information of the first object and the application information of the application where the first object is located before and after the location change event respectively, determining a processing intent for the first object, and obtaining a confirmed result of processing intent; using the first intelligent agent to determine target processing to be performed on the first object after the location change event, based on the confirmed result of processing intent; and using a second intelligent agent to perform the target processing on the first object after the location change event, to obtain a processing result of the first object.

Another aspect of the present disclosure provides an electronic device. The electronic device includes one or more processors and a memory that contains computer instructions that, when being executed causes the one or more processors to perform: in response to detecting a location change event for a first object, using a first intelligent agent to identify object information of the first object and application information of an application where the first object is located before and after the location change event respectively; based on the object information of the first object and the application information of the application where the first object is located before and after the location change event respectively, determining a processing intent for the first object, and obtaining a confirmed result of processing intent; using the first intelligent agent to determine target processing to be performed on the first object after the location change event, based on the confirmed result of processing intent; and using a second intelligent agent to perform the target processing on the first object after the location change event, to obtain a processing result of the first object.

Another aspect of the present disclosure provides a non-transitory computer readable storage medium containing computer instructions that, when being executed causes at least one processor to perform: in response to detecting a location change event for a first object, using a first intelligent agent to identify object information of the first object and application information of an application where the first object is located before and after the location change event respectively; based on the object information of the first object and the application information of the application where the first object is located before and after the location change event respectively, determining a processing intent for the first object, and obtaining a confirmed result of processing intent; using the first intelligent agent to determine target processing to be performed on the first object after the location change event, based on the confirmed result of processing intent; and using a second intelligent agent to perform the target processing on the first object after the location change event, to obtain a processing result of the first object.

Other aspects of the present disclosure may be understood by those skilled in the art in light of the description, the claims, and the drawings of the present disclosure.

### BRIEF DESCRIPTION OF THE DRAWINGS

The following drawings are merely examples for illustrative purposes according to various disclosed embodiments and are not intended to limit the scope of the present disclosure.

FIG. 1 illustrates a flowchart for an operation processing method consistent with the disclosed embodiments of the present disclosure.

FIG. 2 illustrates a schematic diagram of a process of using a first intelligent agent to identify object information of a first object, and application information of applications where the first object is located before and after a location change, consistent with the disclosed embodiments of the present disclosure.

FIG. 3 illustrates another flowchart for an operation processing method consistent with the disclosed embodiments of the present disclosure.

FIG. 4 illustrates an exemplary external appearance of an AI hovering ball, consistent with the disclosed embodiments of the present disclosure.

FIG. 5 illustrates an exemplary implementation process for state control of a second object, consistent with the disclosed embodiments of the present disclosure.

FIG. 6(a) illustrates an example of controlling a second object to be in a text selection interaction state, consistent with the disclosed embodiments of the present disclosure.

FIG. 6(b) illustrates an example of controlling a second object to be in a screenshot interaction state, consistent with the disclosed embodiments of the present disclosure.

FIG. 6(c) illustrates an example of controlling a second object to be in a snippet selection interaction state, consistent with the disclosed embodiments of the present disclosure.

FIG. 7 illustrates an example of an intelligent processing operation for an object based on a location change, consistent with the disclosed embodiments of the present disclosure.

FIG. 8(a) illustrates an example of dragging an image from an Office application to a search box in a web browser, consistent with the disclosed embodiments of the present disclosure.

FIG. 8(b) illustrates an example of processing a first object after a location change, consistent with the disclosed embodiments of the present disclosure.

FIG. 8(c) illustrates an example of retrieving and displaying an intent input interface, consistent with the disclosed embodiments of the present disclosure.

FIG. 8(d) illustrates another example of processing a first object after a location change, consistent with the disclosed embodiments of the present disclosure.

FIG. 9 illustrates a block structural diagram of an operation processing device consistent with the disclosed embodiments of the present disclosure.

FIG. 10 illustrates a block structural diagram of an electronic device consistent with the disclosed embodiments of the present disclosure.

### DETAILED DESCRIPTION

To make the objectives, technical solutions and advantages of the present disclosure more clear and explicit, the present disclosure is described in further detail with accompanying drawings and embodiments. It should be understood that the specific exemplary embodiments described herein are only for explaining the present disclosure and are not intended to limit the present disclosure.

It should be noted that in the present disclosure, relational terms such as “first” and “second” are only configured to distinguish one entity or operation from another entity or operation, and do not necessarily require or imply that such actual relationship or sequence exists between these entities or operations. Terms “comprise”, “include” or any other variations thereof are intended to cover a non-exclusive inclusion. A process, method, article, or apparatus that includes a series of elements includes not only the series of elements, but also other elements not expressly listed, or elements inherent to such a process, method, article, or apparatus. Without further limitation, an element defined by a statement like “comprises a . . . ” does not exclude the presence of additional identical elements in a process, method, article, or apparatus that includes the foregoing element.

It should be noted that relative arrangements of components and operations, numerical expressions and numerical values set forth in exemplary embodiments are for illustration purposes only and are not intended to limit the present disclosure unless otherwise specified. Techniques, methods and apparatus known to the skilled in the relevant art may not be discussed in detail, but these techniques, methods and apparatus should be considered as a part of the specification, where appropriate.

The present disclosure provides an operation processing method and an operation processing device to address issues such as cumbersome operations, low efficiency, and high time consumption, in existing technologies when a user performs related operations across different applications or at different locations within same application. The operation processing method provided in the present disclosure may be applied to various electronic devices, in general-purpose or specialized computing environments or configurations, for example, personal computers, server computers, handheld or portable devices, tablet devices, multi-processor systems, etc.

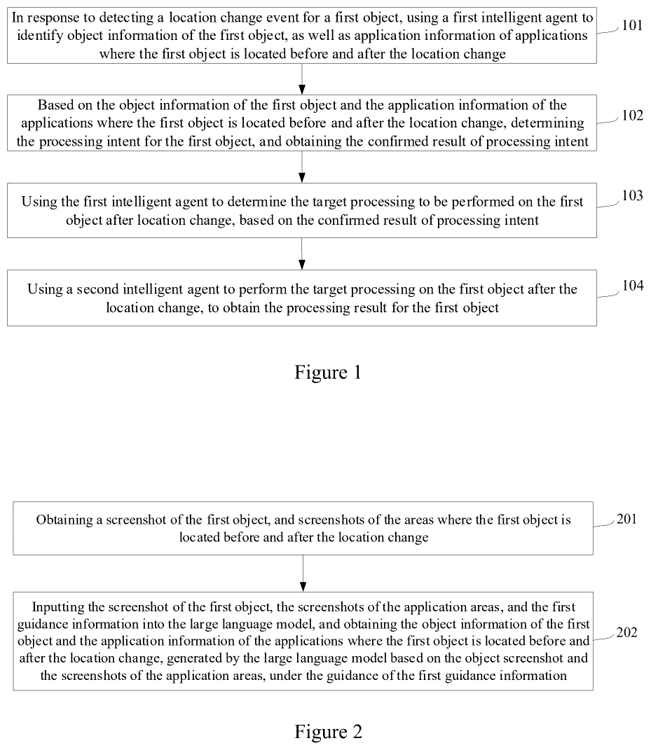

FIG. 1 illustrates a flowchart for an operation processing method consistent with the disclosed embodiments of the present disclosure. Referring to FIG. 1, in one embodiment, the operational processing method provided by the present disclosure at least includes S101 to S104.
S101: in response to detecting a location change event for a first object, using a first intelligent agent to identify object information of the first object, as well as application information of applications where the first object is located before and after the location change.

The first object refers to an operable object of an application. Specifically, the first object may be any suitable type of operable content object in the application, such as text, symbols, images, audio, video, etc., or a part of the operable content, such as keywords, phrases, partial screenshots, video snippets, etc.

In the present disclosure, the term “application” is used to refer to software programs. Subsequently, “first application,” “second application,” etc., also refer to software programs.

The location change event for the first object may be an event triggered either manually by a user or automatically by a machine, based on actual needs, to change the location of the first object. Specifically, the location change event may be achieved, but is not limited to, by performing actions such as dragging, gestures, and/or voice commands on the first object to change the location of the first object, realizing the location change event for the first object.

The location change of the first object may involve moving the first object to a different location within a same application (i.e., non-cross-application location change), or may involve moving the first object between different applications (i.e., cross-application location change). The present disclosure does not limit a specific type of location change, and the type of location change may be determined based on actual needs. For example, a sentence from a Word document may be dragged to a table within a same document to populate the table with content; a keyword/phrase from a Word document may be dragged to a search bar of a search engine to perform a search; or a sentence/paragraph may be dragged from a Word document to the text of an email to add content to the email.

Optionally, in S101, detecting the location change event for the first object may be implemented by one or more of the following: detecting a location change event, such as moving (e.g., dragging) an object from one location to another location within a same application, or moving an object from a first application to a second application, where the first application and the second application are two different applications.

The first intelligent agent may be an Artificial Intelligence (AI) model. Specifically, the first intelligent agent may be a Large Language model (LLM) or other large-scale models. The present disclosure primarily uses a large language model as an example of the first intelligent agent to illustrate proposed solutions.

In one embodiment, in response to detecting a location change event for the first object, the first intelligent agent may be used to identify object information about the first object, as well as the application information of the applications where the first object is located before and after the location change. The object information of the first object may include, but is not limited to, one or more of the following: the object type of the first object, the content type of the data contained in the object, and the data size of the object. The object types may include, but are not limited to, text, images, audio, and video. The content types of the object data may include, but are not limited to, text (including letters, numbers, and symbols), and images (such as pictures of people, landscapes, or animals).

The application information of the applications where the first object is located before and after the location change may be categorized into two types: non-cross-application location change and cross-application location change.

In a case of non-cross-application location change, the application information of the applications where the first object is located before and after the location change, may include, but is not limited to, the application type/name of the same application where the first object is located before and after the location change (e.g., office software, game, communication app, etc.), the different locations within the same application before and after the change (e.g., text area, table area, email body, email subject, etc.), and/or the formatting of the respective location areas before and after the location change (e.g., scaling, alignment, font, text color, etc.).

In a case of cross-application location change, the application information of the applications where the first object is located before and after the location change respectively, may include, but is not limited to, the type/name of the first application where the first object is located before the location change (for example, the first object is located in a Word document), the location of the first object in the first application, and/or the formatting of the location; as well as the type/name of the second application after the location change, the location where the first object is located in the second application (e.g., a sentence may be dragged from a Word document to a location in the body or subject of an email, or an image may be dragged to a location in the body or an attachment of an email), and/or the formatting of the area of the locations where the first object is located.

FIG. 2 illustrates a schematic diagram of a process of using a first intelligent agent to identify object information of a first object, and application information of applications where the first object is located before and after a location change, consistent with the disclosed embodiments of the present disclosure. Referring to FIG. 2, the process of using a first intelligent agent to identify object information of the first object, as well as application information of applications the first object is associated with before and after the location change, may be implemented by S201 and S202.
Step 201: obtaining a screenshot of the first object, and screenshots of the areas where the first object is located before and after the location change.

In response to detecting the location change event for the first object, such as a drag event, the screenshot function of the electronic device may be automatically used to capture the screenshot of the first object, as well as the screenshots of the areas where the first object is located before and after the location change. For example, a screenshot of a piece of text or an image being dragged may be taken, and screenshots of the application windows where the text/image is located before and after being dragged.

In a non-cross-application location change, the screenshots of the areas where the first object is located before and after the location change may include different screenshots of the different locations of the first object in a same application. In a cross-application location change, the screenshots of the areas where the first object is located before and after the location change may include screenshots of the application areas (such as application windows) of the different applications where the first object is located before and after the location change.
S202: inputting the screenshot of the first object, the screenshots of the application areas, and the first guidance information into the large language model, and obtaining the object information of the first object and the application information of the applications where the first object is located before and after the location change, generated by the large language model based on the object screenshot and the screenshots of the application areas, under the guidance of the first guidance information.

Optionally, based on prompt engineering techniques for the large language model, the first guidance information may be generated to guide the large language model to generate the object information and the application information of the applications where the object is located before and after the location change, based on the object screenshot of the first object and the screenshots of the application areas where the object is located before and after the location change (screenshots of different areas in a same application or screenshots of different areas in different applications).

The first guidance information may specifically include, but is not limited to, information such as model roles, role functions, role tasks, and/or task examples, which are designed to achieve the guidance objectives. The large language model may be guided to generate the object information and application formation of the applications where the object is located before and after the location change respectively, by specifying the model roles, role functions, role tasks, and/or providing relevant example tasks.

As such, by inputting the screenshot of the first object, the screenshots of the areas where the first object is located before and after the location change, and the first guidance information into the large language model, the large language model may generate object information of the first object and the application information of the applications where the object is located before and after the location change, based on the object screenshot and the area screenshots, under guidance of the first guidance information.

For a non-cross-application location change, the large language model may specifically generate and output the object information of the first object, as well as relevant application information for the different location areas in a same application before and after the location change, for example, the type/name of the same application, the different locations of the first object in the same application before and after the location change (such as text area location, table area location), and the corresponding formatting at each location. For a cross-application location change, the large language model may specifically generate and output the object information of the first object, as well as the application information of the first application and the second application where the object is located before and after the location change, such as the type/name of the first application before the location change, the corresponding location in the first application, and the content format at the location, as well as the type/name of the second application after the location change, the corresponding location in the second application, and the content format at the location.
S102: based on the object information of the first object and the application information of the applications where the first object is located before and after the location change, determining the processing intent for the first object, and obtaining the confirmed result of processing intent.

The processing intent for the first object may indicate the purpose of the operation performed on the first object. The processing intent for the first object may include, but is not limited to, automatically adjusting the formatting of the first object to match the new location after the location change, generating table content based on the original data, generating and sending emails, and retrieving data.

In an optional embodiment, S102 may utilize the first intelligent agent, including a large model, such as a large language model, to determine the processing intent for the first object. In one embodiment, optionally, based on prompt engineering techniques for large language models, a second guidance instruction may be set to direct the large language model to determine the processing intent for the first object, based on the object information and the application information of the applications where the first object is located before and after the location change.

The second guidance information may include, but is not limited to, information such as model roles, role functions, role tasks, and/or task examples. Such information is set to align with the guidance objectives of the second guidance information for the large language model.

Based on this, the object information of the first object, the application information of the applications where the first object is located before and after the location change, and the second guidance information may be input into the large language model. As such, guided by the second guidance information, the large language model may generate the first processing intent for the first object. The first processing intent may serve as the confirmed result of processing intent for the first object.

In some other embodiments, an intent understanding dataset may be pre-built, for example, by using historical user operation data to create an intent understanding database. An intent understanding dataset, such as an intent understanding database, may include one or more pieces of intent understanding data. Each piece of intent understanding data may include object information about the corresponding object, the application information of the applications where the object is located before and after the location change (including cross-application location change and non-cross-application location change), and the processing intent for the object.

In one implementation, the processing intent for the first object may be determined by querying the intent understanding dataset to find the second processing intent that matches the object information and application information of the applications where the first object is located before and after the location change.

In practical implementations, the above two approaches may be used in combination. For example, in cases where the intent understanding dataset is empty or lacks sufficient data, a large language model may be used to determine the first processing intent for the first object. When the intent understanding dataset includes sufficient data, in addition to using the large language model to determine the first processing intent for the first object, the system may also determine the second processing intent for the first object based on the intent understanding dataset, and uses the first processing intent and second processing intent together as the confirmed result of processing intent for the first object. In this approach, the processing intent for the first object includes the first processing intent and the second processing intent.
S103: using the first intelligent agent to determine the target processing to be performed on the first object after location change, based on the confirmed result of processing intent.

The confirmed result of processing intent may include one or more processing intents for the first object, depending on actual intent recognition results. For example, after dragging a sentence from a Word document into text an email, based on a large language model and/or an intent understanding dataset, the intent identification result of the processing intents may include, but are not limited to Intent 1, Intent 2 and Intent 3, as described below.
Intent 1: inserting the sentence into the email text as part of the email text, automatically adapting the sentence to match the current formatting of the email text.
Intent 2: searching the sentence or keywords of the sentence using a search engine, including search results as a part of the email text, and automatically adapting the search results to match the current formatting of the email text. For example, a person's name in the sentence may be searched, the retrieved biographical information may be inserted into the email text, and the formatting of the biographical information may be automatically adapted to match the current formatting of the email text. Alternatively, a specific technical term in the sentence may be searched, the relevant explanation for the technical term may be inserted into the email text, and the formatting of the relevant explanation may be automatically formatted to match the current formatting of the email text.
Intent 3: searching the sentence or keywords of the sentence using a search engine, and attaching the search result as an email attachment. For example, a specific name of a person or a technical term in the sentence may be searched, and then the relevant documents (such as articles published by the person or articles related to the technical term) may be used as an email attachment.

After obtaining the confirmed result of processing intent for the first object, when the confirmed result of processing intent includes only a single processing intent for the first object, optionally, the single processing intent may be directly used as the target intent for the first object, to determine the target processing to be performed on the first object after the location change. When the confirmed result of processing intent includes a plurality of processing intents for the first object, based on the weights assigned to each of the plurality of processing intents, one processing intent that meets the weight criteria (for example, the highest weight) may be selected as the target intent for the first object, to determine the target processing to be performed on the first object after the location change.

The weights corresponding to different processing intents may be provided by the large language model during intent recognition based on the model capabilities of the large language model, or may be pre-set based on the historical frequency of actual execution of different processing intents in the intent understanding dataset. For different processing intents corresponding to a same location change event of a same object, the higher the historical frequency of actual execution of a particular processing intent, the higher the weight of the processing intent, and thus the higher the probability that the processing intent may be selected as the final target intent in subsequent processing.

In real applications, the processing intent for the first object (whether a processing single intent or a plurality of processing intents) determined based on large language models and/or intent understanding datasets may not match the user's actual processing intent for the first object. To address such a situation, optionally, the identified single intent or the identified plurality of processing intents for the first object may be displayed, such that the user may review and confirm the processing intent. An intent interactive interface may be provided, and the user may submit the actual processing intent for the first object when the displayed intent does not match the actual requirements.

The intent interaction interface may be implemented in various ways, such as a chat window, and may allow a user to submit the desired processing intent to the interface via text input, voice input, and/or gestures. In addition, the chat window may be set to hide or display, such that a user may manage the chat window according to needs.

Accordingly, when the confirmed result of processing intent indicates that the processing intent for the first object is a single processing intent, either the single processing intent or a first intent input by the user may be taken as the target intent for the first object, and may be used to determine the target processing to be performed on the first object after the location change.

When the confirmed result of processing intent indicates that a plurality of processing intents exist for the first object, a processing intent may be selected from the plurality of processing intents, or a second intent may be obtained from the user's input, to serve as the target intent for the first object. The target intent may then be used to determine the target processing to be performed on the first object after the location change. The intent input unit may be, but is not limited to, a keyboard/mouse, a user's finger, a stylus, etc.

Based on this, the target intent and third guidance information may be input into the large language model, resulting in an operation sequence generated by the model, under the guidance of the third guidance information, to fulfill the target intent. The operation sequence may indicate one or more operations to be performed on the first object, representing the target processing to be performed on the first object after the location change.

For example, considering the location change of “dragging a sentence from a Word document to the text of an email,” the identified processing intent for the sentence may be the intent 2, that is, “searching the sentence or keywords of the sentence using a search engine, including search results as a part of the email text, and automatically adapting the search results to match the current formatting of the email text.” Accordingly, the operation sequence output by the large language model may include: extracting keywords from the sentence→constructing a search query using the extracted keywords→submitting the search query to a search engine to perform searching→identifying the current formatting of the email text→inserting the search results into the email text at the designated location, following the identified current formatting.

It should be noted that, when the operation sequence includes a plurality of operations, the plurality of operations may be executed sequentially or in parallel, depending on the actual relationship between the pluralities of operations (such as, whether there are any dependencies). For example, in the above operations sequence, the operation “constructing a search query using the extracted keywords” depends on the previous operation “extracting keywords from the sentence.” Accordingly, the operation “constructing a search query using the extracted keywords” and the operation “extracting keywords from the sentence” need to be executed sequentially. The operations of “constructing a search query using the extracted keywords” and “identifying the current formatting of the email text” are independent of each other. Accordingly, the operations of “constructing a search query using the extracted keywords” and “identifying the current formatting of the email text” may be executed in parallel. For different operations that have no dependencies, the operations may also be executed sequentially. A specific execution approach may be determined based on the actual situation of resource allocation.

The third guidance information may be used to instruct the large language model to generate an operation sequence that fulfills the target intent. In practice, the third guidance information may be configured using prompt engineering techniques for large language models. The third guidance information may include, but is not limited to, information such as the as model roles, role functions, role tasks, and/or task examples. Such information is designed to serve the purpose of guiding the large language model to generate an operation sequence that fulfills the target intent.
Step 104: using a second intelligent agent to perform the target processing on the first object after the location change, to obtain the processing result for the first object. The second intelligent agent may also be an AI model, such as a Large Action Model (LAM).

After determining the operation sequence to be performed on the first object after location change, an AI model, such as a large action model, may then be used to execute the operations indicated by the operation sequence on the first object after the location change. When the operation sequence includes a plurality of operations, different operations in the operation sequence may be performed on the first object after the location change, sequentially or in parallel, as required, and the processing result for the first object may thus be automatically generated.

In existing technologies, when copying and pasting text within a same application, formatting often needs to be adjusted. For instance, when copying colored text with a white background from a PowerPoint slide and pasting the colored text into an area with a black background, formatting needs to be adjusted to match the new background color. When copying text from a Word document into a table, formatting needs to be adjusted to match the formatting of the table. For an application scenario in a same application, in the present disclosure, a first intelligent agent, such as a large language model, may be used to identify the object information of the text that is moved (location change), as well as the area information of the areas where the text is located before and after the location change (e.g., the white background area and black background area in a PowerPoint presentation, or the text area and table area in a Word document). Then, the processing intent for the moved text may be determined, and operation sequence to fulfill the processing intent may be determined. After that, a second intelligent agent, such as a large action model, may be used to automatically perform the operations indicated by the operation sequence, on the text after location change, and the the processing result of the text after location change may be automatically generated. For example, the text color may be automatically adjusted when the text is moved to a black background area in PowerPoint to match the background color, and the font size, font style, alignment, and/or color of the text moved to a table in a Word document may be automatically adjusted to match the formatting of the table.

In existing technologies, cross-application copying and pasting may not produce expected results. For instance, when copying text from a PowerPoint presentation and pasting the text into WeChat, the copied text may be converted into an image. Copying a table from an Excel file to a PowerPoint file may require additional time to format the table. To address this issue, in the present disclosure, a first intelligent agent, such as a large language model may be used to identify the object information of the object being moved (e.g., text, table), and the application information of the applications where the object is located before and after the location change. The processing intent for transferring the object across applications, and the operation sequence for achieving the processing intent, may then be determined. In addition, a second intelligent agent, such as a large action models, may be used to automatically perform the operations specified by the operation sequence on the text and images after the location change across different applications, and the processing results for the text and images after the location change may be automatically generated. For example, the formatting of the text transferred from a PowerPoint file to WeChat may be automatically adjusted, such that the text may maintain the original character type, and adapt to the current formatting of the area in WeChat. Similarly, the formatting of the text transferred from an Excel file to a PowerPoint file may be automatically adjusted to adapt to the current formatting of the location in the PowerPoint file.

As such, with the operation processing method provided by the present disclosure, for a location change event of a first object, a first intelligent agent may be used to identify the object information of the first object and the application information of the applications where the first object is located before and after the location change. Based on the identification results, the processing intent for the first object, and the corresponding target processing to be performed on the first object after the location change may be determined. Subsequently, a second execution unit may perform the target processing on the first object after the location change, automatically generating the processing result of the first object after the location change. Accordingly, the complexity of user operation in scenarios involving a location change across different applications or within a same application may be reduced, operational efficiency may be improved, and time consumption may be reduced.

The operation processing method provided by the present disclosure also allows a user to move each type of object to a different location within a same application or to a different application, using shortcuts such as drag-and-drop, voice and/or gesture control, in a single operation. Accordingly, cumbersome operations required by existing technologies to achieve cross-application and non-cross-application object location changes may be avoided. As a result, user convenience may be enhanced, and overall user experience may be improved.

In an optional embodiment, the operation processing method provided by the present disclosure may also include at least one of S1-1 and S1-2.
S1-1: based on the object information of the first object, the application information of the applications where the first object is located before and after the location change, and the actual processing intent for the first object, updating the intent understanding dataset.

The actual processing intent, when the processing intent for the first object is a single intent as represented by the confirmed result of processing intent, may refer to the single intent, or may refer to the first intent input by the user. Alternatively, when the processing intent for the first object includes a plurality of intents as represented by the confirmed result of processing intent, the actual processing intent may refer to an intent selected from the plurality of intents, or a second intent input by the user, depending on the specific application scenario.

An operation of, based on the object information of the first object, the application information of the applications where the first object is located before and after the location change, and the actual processing intent for the first object, updating the intent understanding dataset, may include but not limited to: when the intent understanding dataset does not include the object information about the first object, the application information of the applications where the first object is located before and after the location change, and the actual processing intent for the first object, adding the object information about the first object, the application information of the applications where the first object is located before and after the location change, and the actual processing intent for the first object, to the intent understanding dataset; and when the intent understanding dataset includes the object information about the first object, the application information of the applications where the first object is located before and after the location change, and the actual processing intent for the first object, updating the object information about the first object, the application information of the applications where the first object is located before and after the location change, and the execution frequency of the actual processing intent of the first object, in the intent understanding dataset.

By updating the intent understanding dataset based on the object information of the first object, the application information of the applications where the first object is located before and after the location change, and the actual processing intent for the first object, the intent understanding dataset may be enriched and improved, and may provide richer data as a basis for recognition of processing intents for subsequent object location change events.
S1-2: based on the execution frequency of different processing intents for the object within the intent understanding dataset, determining the weight of each different processing intent for the object.

For a same location change event of an object, there may exist a plurality of different processing intents. In this case, the weight of each processing intent for the object may be determined based on the execution frequency of different processing intents for the same location change event in historical operations. The higher the execution frequency of a processing intent, the higher the corresponding weight; and conversely, the lower the execution frequency, the lower the corresponding weight. Subsequently, when identifying the processing intent for the first object in response to the location change event, based on the weights of different processing intents for the object in the intent understanding dataset, the identified processing intents for the first object may be ranked accordingly. Optionally, the intent with a higher weight may be displayed higher in the list, such that the user may identify and select the intent option that matches the actual purpose.

It may be understood that, as a user continuously apply location change events to objects based on actual needs, and for each location change event, perform a corresponding operation on the object after the location change, by actually executing/following a corresponding processing intent, the execution frequency of different processing intents for the object within the intent understanding dataset may be dynamically updated.

As such, the intent understanding dataset may be updated based on the object information of the first object, the application information of the applications where the first object is located before and after the location change, and the actual processing intent for the first object. Accordingly, the intent understanding dataset may be enriched and improved, and a more comprehensive data foundation may be provided for subsequent analysis and identification of intent in object location change events. Based on the execution frequency of different processing intents for objects within the intent understanding dataset, the weight of each processing intent for the object may be determined. Subsequently, when identifying the processing intent for the first object in response to the location change event, each identified processing intent may be sequenced based on the respective weight. Accordingly, a user may quickly and efficiently identify and select the appropriate intent option that matches the intended purpose, and the user efficiency may thus be improved.

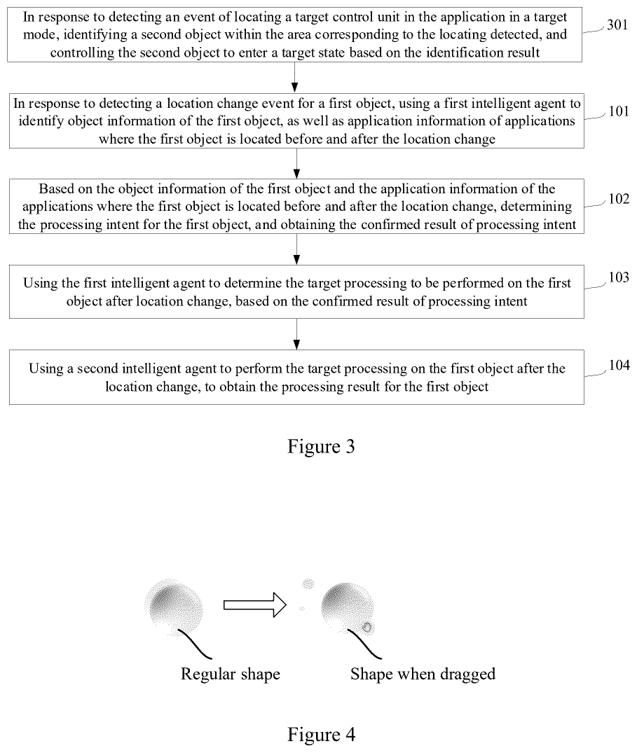

FIG. 3 illustrates another flowchart for an operation processing method consistent with the disclosed embodiments of the present disclosure. In an optional embodiment, referring to FIG. 3, before detecting the object's location change event, the operation processing method may also include S301: in response to detecting an event of locating a target control unit in the application in a target mode, identifying a second object within the area corresponding to the locating detected, and controlling the second object to enter a target state based on the identification result. The target state refers to a state for selecting at least a part of the structural components of the second object. The first object refers to the selected part of the structural components of the second object.

The target mode refers to a mode that uses the operation processing method provided by the present disclosure to automatically process an object that experiences a location change, and generates processing results for the object. A user may choose to enable or disable the target mode based on actual needs or preferences. With the target mode disabled, a user may perform a location change for an object using standard operating procedures, and then perform necessary operations on the object. For example, after copying a table from an Excel file to a PowerPoint file, the formatting of the table in PowerPoint may be manually adjusted to match the PowerPoint formatting standards; and when copying text within a same application, the text formatting may be manually adjusted at the new location to match the formatting requirements of the new location.

The target control unit is configured for determining a location in the application. A user may move the target control unit by dragging, voice control, and/or gesture control. By moving the target control unit to a desired location, precise location targeting in the application may be achieved. The target control unit may be implemented in various forms, such as a hovering ball. In one embodiment, the target control unit is specifically implemented as an AI hovering ball that may be moved around on the screen. FIG. 4 illustrates an exemplary external appearance of an AI hovering ball, consistent with the disclosed embodiments of the present disclosure. Referring to FIG. 4, the location of the AI hovering ball may be adjusted via methods such as dragging, voice control, and/or gesture control.

When a user needs to select a second object or a component of the second object in an application to perform a location change for the selected first object (which may be the second object or a part of the second object), the target control unit (such as an AI hovering ball) may be moved to the location of the second target object by dragging the target control unit. In this way, the area of the desired second object may be located using the target control unit.

In response to an event detecting the location of the target control unit in an application in a target mode, in one embodiment, the second object in the area corresponding to the detected location may be identified. Specifically, the type of the second object may be identified, such as whether the second object is text, an image, or audio/video. Then, based on the identification result, the second object may be controlled to be in a target state. Specifically, the target state refers to a state where at least a part of the structural components of the second object may be selected, and the target state matches the type of the second object.

When the identification result indicates that the second object is text, the target state may be a first state for selecting text content, and the second object may be controlled to be in the first state that the text content is selected. The first state may specifically, but is not limited to, be a text selection interaction state that supports selecting one or more keywords, phrases, sentences, paragraphs, etc. within the second object, allowing users to select part or each of the text content of the second object through text selection interactions.

When the identification result indicates that the second object is an image, the target state may be a second state for taking a screenshot of the image content, and the second object may be controlled to be in the second state for taking a screenshot. The second state may specifically, but is not limited to, be a screenshot interaction state that supports capturing screenshots of part or each of the image content of the second object, allowing users to select part of or each of the image content of the second object through screenshot interaction or similar methods.

When the identification result indicates that the second object is an audio/video file, the target state may be a third state for selecting specific segments of the audio/video file, and the second object may be controlled to enter the third state for segment selection. The third state, specifically, may include, but is not limited to, an interactive selection mode that allows users to select specific segments of the audio/video timeline of the second object, and part of or each of the audio/video content of the second object may thus be selected based on the interactive selection method.

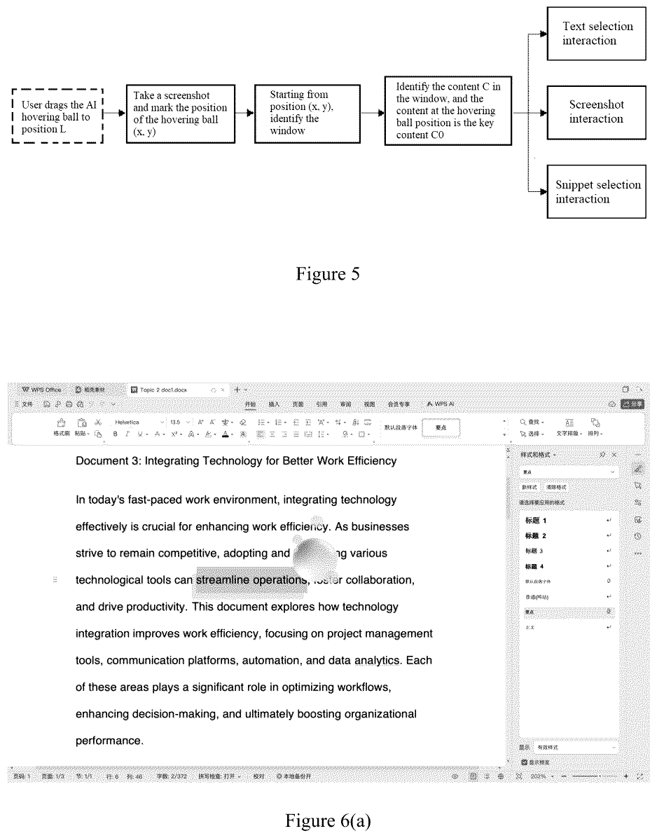

FIG. 5 illustrates an exemplary implementation process for state control of a second object, consistent with the disclosed embodiments of the present disclosure. Referring to FIG. 5, in one embodiment, in the target mode, a user may drag the AI hovering ball to a desired location in the application to identify the location. In response to the event of detecting the AI hovering ball, as a target control unit, being positioned within the application in target mode, a screenshot of the target area may be taken, and the position (x, y) of the AI hovering ball may be identified and marked. Next, using the coordinates (x, y) as a starting point, the object (the second object) within the target area may be identified, for example, the type of content within a window may be identified.

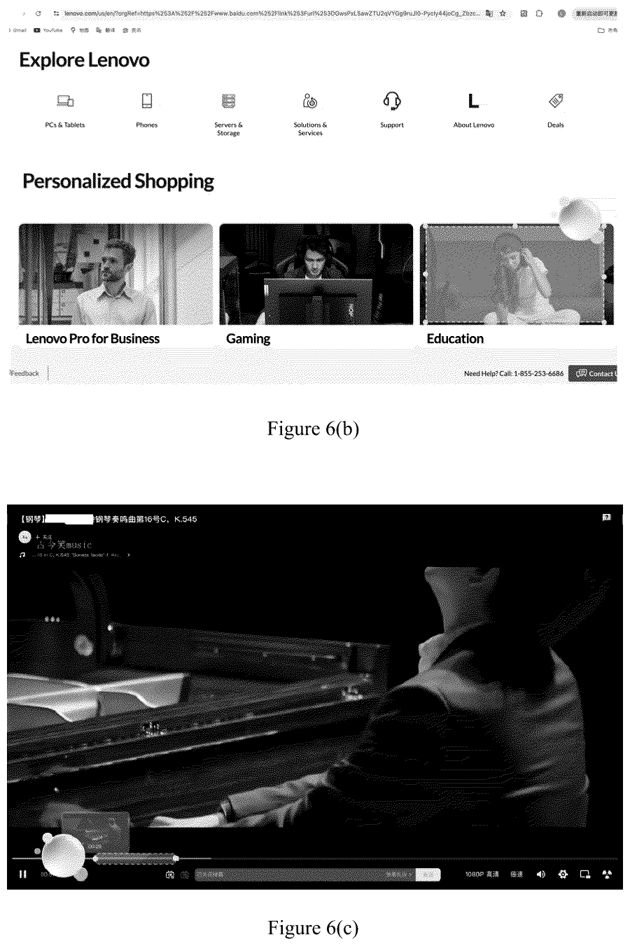

Based on this, according to the identified content type of the second object, the second object may be controlled to enter a corresponding target state. When the second object is text, the second object may be controlled to be in a text selection interaction state. FIG. 6(a) illustrates an example of controlling a second object to be in a text selection interaction state, consistent with the disclosed embodiments of the present disclosure. As shown in FIG. 6(a), in this state, a user may select part of or each of the text content in the second object (such as keywords, sentences, or paragraphs) by interacting with the second object using text selection. When the second object is an image, the second object may be controlled to be in a screenshot interaction mode. FIG. 6(b) illustrates an example of controlling a second object to be in a screenshot interaction state, consistent with the disclosed embodiments of the present disclosure. As shown in FIG. 6(b), in this state, a user may select part of or each of the image content of the second object by taking a screenshot of the second object. When the second object is an audio/video file, the second object may be controlled to enter a snippet selection interaction mode, and a user may select specific segments in the audio/video progress bar. FIG. 6(c) illustrates an example of controlling a second object to be in a snippet selection interaction state, consistent with the disclosed embodiments of the present disclosure. As shown in FIG. 6(c), in this state, a user may select a portion of or each of the audio/video file of the second object by using the audio/video progress bar of the second object.

The partially or entirely selected text, images, audio/video clips, or other objects may be used as the first object. Subsequently, a location change event may be performed on the first object. Based on the method provided in the present disclosure, an intelligent agent may be used to perform tasks such as intent recognition and operation sequence determination. Corresponding actions may be automatically executed on the first object after the location change, and intelligent processing result of the first object after location change may be achieved.

It should be noted that the above-mentioned interaction states, such as text selection interaction, screenshot interaction, and snippet selection interaction, are merely illustrative examples of how the target state may be implemented, and are not intended to limit the scope of the target state. In practice, any implementation that may control the second object to allow selection of part of or each of the content of the second object, based on the recognition result, falls within the scope of the present disclosure.

In the present disclosure, a target control unit may be set for positioning a location in an application. In response to an event that detects the positioning of a target control unit in the application in the target mode, the second object located within the area corresponding to the positioned location may be identified, and based on the recognition results, the second object may be controlled to be in the target state. As such, a user may quickly and efficiently select part of or each of the structural components of the second object in the designated area. The selected results may be used as the first object for subsequent location change events and automated operations based on intelligent agents. Accordingly, operation efficiency may be improved for location change of objects between different locations in a same application or across different applications, as well as for performing related operations.

The following provides application examples of the method provided by the present disclosure. In one example, the target mode is implemented as an intelligent drag-and-drop mode. A user may perform location change on a selected object by dragging the object and perform intelligent operations based on the location change.

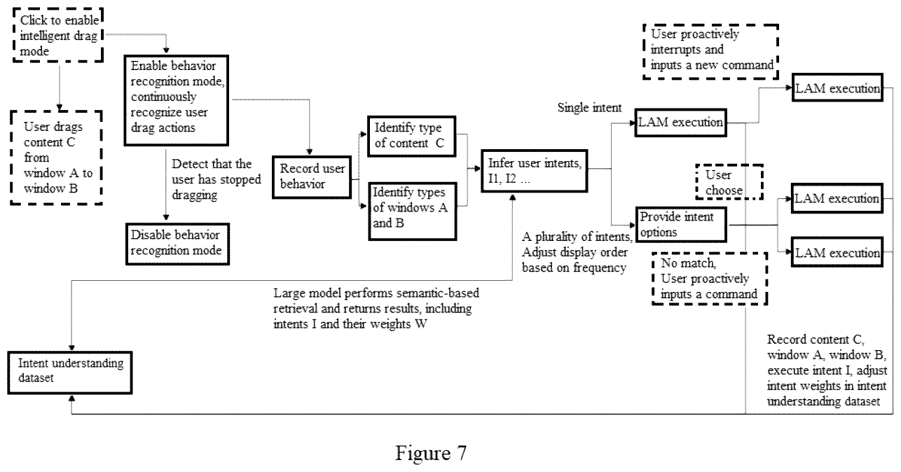

FIG. 7 illustrates an example of an intelligent processing operation for an object based on a location change, consistent with the disclosed embodiments of the present disclosure. Referring to FIG. 7, in one example, a user may first activate/open the intelligent drag-and-drop mode. Then, based on practical needs, the user may drag content C (i.e., the first object, which may be text, images, audio/video, or a part of the text, images, audio/video) from window A to window B, thus achieving the location change of the position of content C. A large language model (LLM) may then be used to identify content C, as well as window A and window B, and determine the appropriate processing intent for content C based on the identification results. Specifically, based on a large language model and/or an intent understanding database, one or more processing intents (I1, I2, etc.) for content C may be determined and displayed. When a plurality of processing intents is identified, the display order of the processing intents may be adjusted based on respective weights. As such, the user may select the desired processing intent from the displayed list or enter a desired processing intent. Then, an operation sequence may be determined to achieve the desired intent. A large action model (LAM) may be used to perform the operations specified by the operation sequence on the content C after location change, resulting in the processing result of content C after location change. After that, the content C and relevant information about the two windows, as well as the processing intent executed, may be recorded. Based on the recorded information, the intent understanding database may be updated (e.g., by adding records to the dataset and/or adjusting the intent weights).

The application scenarios for the operation processing method provided by the present disclosure may include, but are not limited to: first scenario, dragging and dropping an image/video or part of an image/video from an Office application into a folder for directly saving; second scenario, dragging an image or part of an image from an Office application into a web browser to search for similar images; and third scenario, automatically adjusting the text color, size, etc., of the dragged content in an Office application to match the current formatting of the location after location change.

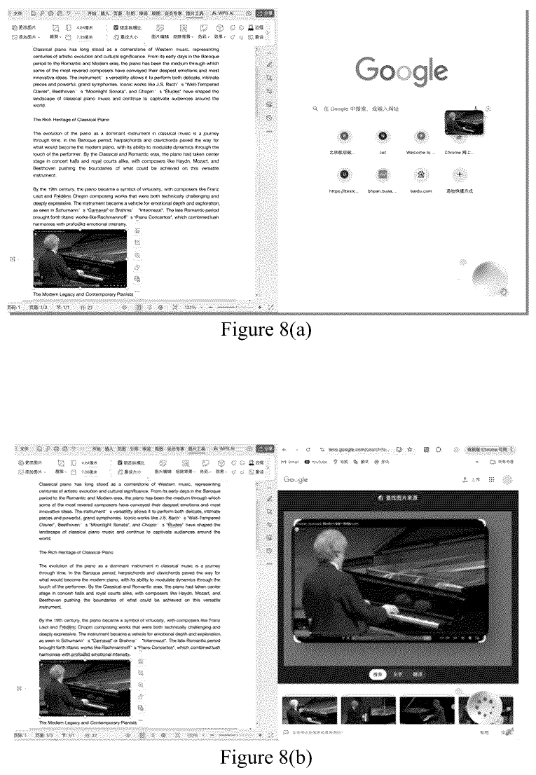

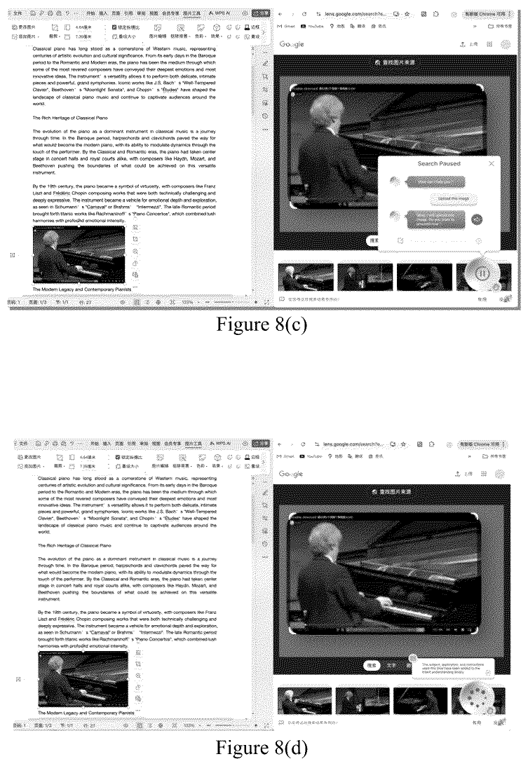

FIG. 8(a) illustrates an example of dragging an image from an Office application to a search box in a web browser, consistent with the disclosed embodiments of the present disclosure. Taking the second scenario as an example, as shown in FIG. 8(a), a user may drag an image from an Office application into the search box of the web browser.

Based on this, the processing intent for the image may be determined using the method provided by the present disclosure. When the confirmed result of processing intent is a single intent, and the user has no objections, necessary operations on the image after location change to fulfill the single intent may be automatically determined and executed. For example, the image may be used to create search criteria to find similar images.

FIG. 8(b) illustrates an example of processing a first object after a location change, consistent with the disclosed embodiments of the present disclosure. During the process, as shown in FIG. 8(b), the AI hovering ball icon may be used and controlled to be in a specific status, indicating that a corresponding operation (such as similar image search) is being performed on the first object (as shown in FIG. 8(a)) after the location change.

A plurality of processing intents may be identified after dragging and moving an image. In this scenario, a user may be provided with intent options for selecting from the plurality of processing intents. The display order of the intent options may be determined based on the respective weights of the processing intents. The user may select a processing intent by clicking one of the options, such that the corresponding operation on the dragged and moved image may be automatically performed based on the selected intent. Alternatively, when the user's desired intent is not among the available options, an intent input interface may be displayed. FIG. 8(c) illustrates an example of retrieving and displaying an intent input interface, consistent with the disclosed embodiments of the present disclosure. Optionally, as shown FIG. 8(c), a user may access the intent input interface by clicking the AI hovering ball icon on the screen, and the intent needed may be input through the intent input interface. FIG. 8(d) illustrates another example of processing a first object after a location change, consistent with the disclosed embodiments of the present disclosure. As shown in FIG. 8(d), the operation process matching the user's processing intent may be automatically performed on the dragged and moved image. Accordingly, by using an intelligent agent to recognize the user intent and automate operations for the dragged and moved object, the complexity and time consumption required for user operations may be reduced, and operational efficiency may be improved.

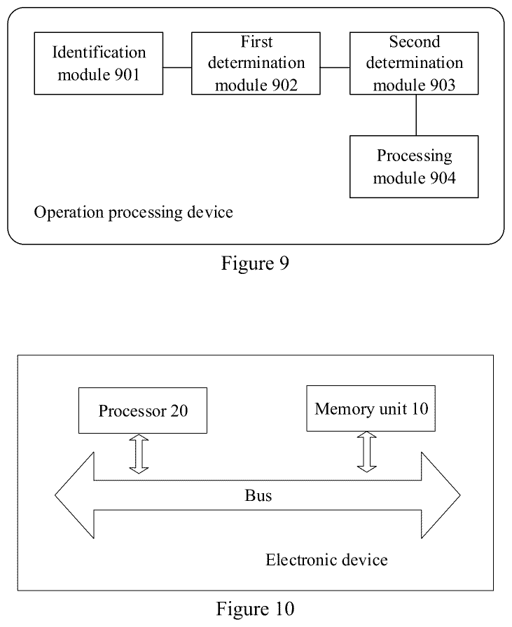

The present disclosure also provides an operation processing device. FIG. 9 illustrates a block structural diagram of an operation processing device consistent with the disclosed embodiments of the present disclosure. Referring to FIG. 9, the operation processing device may include an identification module 901, a first determination module 902, a second determination module 903 and a processing module 904.

In response to detecting a location change event for a first object, the identification module 901 may use a first intelligent agent to identify information about the first object, as well as the application information of the applications where the first object is located before and after the location change.

The first determination module 902 is configured to determine the processing intent for the first object based on the object information of the first object and the application information of the applications where the first object is located before and after the location change, and output the confirmed result of processing intent.

The second determination module 903 is configured to use a first intelligent agent to determine the target processing operation to be performed on the first object after the location change, based on the confirmed result of processing intent.

The processing module 904 is configured to use a second intelligent agent to perform the target processing operation on the first object after the location change, and obtain the processing result for the first object.

In an optional embodiment, the device may also include a detection module for detecting location change events of the first object. Detecting the location change events of the first object by the detection module, may include at least one of the following: detecting the location change event when the first object is dragged from a first location to a second location in the application where the first object is located; and detecting an event where the object is dragged from a first application and to a second application.

In an optional embodiment, the identification module 901 is specifically configured to obtain the screenshot of the first object, and the screenshots of the areas where the first object is located before and after the location change. The identification module 901 is also specifically configured to input the screenshot of the object, the screenshots of the areas, and the first guidance information into the large language model, and obtain the object information of the first object, as well as the application information of the applications where the first object is located before and after the location change, generated by the large language model based on the object screenshot and the area screenshots, under the guidance of the first guidance information,

In an optional embodiment, the first determination module 902 is specifically configured to input the object information of the first object, the application information of the applications where the first object is located before and after the location change, and the second guidance information into the large language model, and obtain the first processing intent for the first object, generated by the large language model under the guidance of the secondary information. The first determination module 902 is also specifically configured to, from the intent understanding dataset, determine the second processing intent matching the object information and application information of the applications where the first object is located before and after the location change.

The processing intent for the first object includes at least one of the first processing intent and the second processing intent. The intent understanding dataset includes at least one piece of intent understanding data. Each piece of data includes the object information about a corresponding object, the application information of the applications where the object is located before and after the location change, and the processing intent for the corresponding object.

In an optional embodiment, the device may also include a post-processing module. The post-processing module is configured to perform at least one of the following: based on the object information of the first object, the application information of the applications where the first object is located before and after the location change, and the actual processing intent for the first object, updating the intent understanding dataset; and based on the execution frequency of different processing intents for objects in the intent understanding dataset, determining the weight of each different processing intent for the object.

In an optional embodiment, the second determination module 903 is specifically configured to input the target intent and the third guidance information into the large language model, and obtain the operation sequence generated by the large language model under guidance of the third guidance information, to fulfill the target intent. The operation sequence is configured to specify one or more operations to be performed on the first object, and the target intent is an intent obtained based on the confirmed result of processing intents.

The processing module 904 is specifically configured to use a large action model to perform the operations indicated by the operation sequence on the first object after the location change.

In an optional embodiment, the process of obtaining the target intent includes, when the confirmed result of processing intent indicates that the processing intent for the first object is a single intent, obtaining the single intent or obtaining a first intent input by the user. The target intent is the single intent or the first intent. The process of obtaining the target intent also includes, when the confirmed result of processing intent indicates that a plurality of processing intents exists for processing the first object, obtaining an intent selected from the plurality of processing intents, or obtaining a second intent input by the user. The target intent is the intent selected from the plurality of processing intents, or the second intent.

In an optional embodiment, the device may also include a control module. The control module is configured to, prior to detecting a location change of an object, in response to an event that detects the positioning of a target control unit in the application in a target mode, identify a second object located in the area corresponding to the location positioned by the target control unit, and control the second object to be in a target state based on the recognition result.

The target state refers to a state for selecting at least a part of the structural components of the second object. The first object refers to the selected part of the structural components of the second object.

In an optional embodiment, when controlling the second object to be in the target state based on the recognition result, the control module is specifically configured for: when the recognition result indicates that the second object is text, controlling the second object to be in a first state that allows for selecting the text content; when the recognition result indicates that the second object is an image, controlling the second object to be in a second state that allows for capturing a screenshot of the image content; and when the recognition result indicates that the second object is an audio/video file, controlling the second object to be in a third state that allows for selecting specific segments of the audio/video file.

The present disclosure also provides an electronic device. FIG. 10 illustrates a block structural diagram of an electronic device consistent with the disclosed embodiments of the present disclosure. As shown in FIG. 10, the electronic device at least includes a memory unit 10 and a processor 20.

The memory unit 10 is configured to store a computer instruction set. The computer instruction set may be implemented in the form of a computer program.

The processor 20 is configured to implement the operation processing method provided by the present disclosure, by executing the computer instruction set. The processor 20 may be a Central Processing Unit (CPU), an Application-Specific Integrated Circuit (ASIC), a Digital Signal Processor (DSP), a Field-Programmable Gate Array (FPGA), a Neural-network Processing Unit (NPU), a Deep-learning Processing Unit (DPU), or other programmable logic devices.

The electronic device may include a built-in display or a display interface, and may be connected to an external display device. Optionally, the electronic device may also include a camera component, and/or may be connected to an external camera component.

In addition, the electronic device may also include components such as a communication interface and a communication bus. The memory, the processor, and the communication interface may communicate with each other via the communication buses. The communication interface is configured for communication between the electronic device and other devices. The communication bus may be a Peripheral Component Interconnect (PCI) bus or an Extended Industry standard Architecture (EISA) bus, etc. The communication bus may be classified as an address bus, a data bus, a control bus, etc.

The present disclosure also provides a storage medium. The storage medium includes one or more computer instruction sets. When one or more of the computer instruction sets are executed by an electronic device, the electronic device may perform the operation processing method provided by the present disclosure.

Those skilled in the art may understand that the present disclosure may be implemented with software combined with a standard general-purpose hardware platform. Based on this understanding, the core technical solution and the aspects forming the creative contribution of the present disclosure may be embodied in the form of a software product. The computer software product may be stored on a storage medium, such as ROM/RAM, magnetic disk, or optical disc. The computer software product may include instructions configured for a computer device (which may be a personal computer, a server, or a network device, etc.) to perform the method provided by the present disclosure.

As disclosed, the technical solutions of the present disclosure have the following advantages.

With the operation processing method provided by the present disclosure, for a location change event of a first object, a first intelligent agent may be used to identify the object information of the first object and the application information of the applications where the first object is located before and after the location change. Based on the identification results, the processing intent for the first object, and the corresponding target processing to be performed on the first object after the location change may be determined. Subsequently, a second execution unit may perform the target processing on the first object after the location change, automatically generating the processing result of the first object after the location change. Accordingly, the complexity of user operation in scenarios involving a location change across different applications or within a same application may be reduced, operational efficiency may be improved, and time consumption may be reduced.

The operation processing method provided by the present disclosure also allows a user to move each type of object to a different location within a same application or to a different application, using shortcuts such as drag-and-drop, and voice and/or gesture control, in a single operation. Accordingly, cumbersome operations required by existing technologies to achieve cross-application and non-cross-application location changes may be avoided. As a result, user convenience may be enhanced, and overall user experience may be improved.

The embodiments disclosed in the present disclosure are exemplary only and not limiting the scope of the present disclosure. Various combinations, alternations, modifications, or equivalents to the technical solutions of the disclosed embodiments may be obvious to those skilled in the art and may be included in the present disclosure. Without departing from the spirit of the present disclosure, the technical solutions of the present disclosure may be implemented by other embodiments, and such other embodiments are intended to be encompassed within the scope of the present disclosure.

What is claimed is:

1. An operation processing method, comprising:
in response to detecting a location change event for a first object, using a first intelligent agent to identify object information of the first object and application information of an application where the first object is located before and after the location change event respectively;
based on the object information of the first object and the application information of the application where the first object is located before and after the location change event respectively, determining a processing intent for the first object, and obtaining a confirmed result of processing intent;
using the first intelligent agent to determine target processing to be performed on the first object after the location change event, based on the confirmed result of processing intent; and
using a second intelligent agent to perform the target processing on the first object after the location change event, to obtain a processing result of the first object.

2. The method according to claim 1, wherein an operation of detecting the location change
event for the first object includes at least one of:
detecting a location change of dragging the first object from a first location to a second location in the application where the first object is located; or
detecting a location change of dragging an object in a first application to a second application.

3. The method according to claim 1, wherein an operation of using the first intelligent agent to identify the object information of the first object, and the application information of the application where the first object is located before and after the location change event respectively, includes:
obtaining an object screenshot of the first object, and area screenshots of areas where the first object is located before and after the location change event respectively; and
inputting the object screenshot, the area screenshots, and first guidance information into a large language model, and obtaining the object information of the first object and the application information of the application where the first object is located before and after the location change event respectively, generated by the large language model based on the object screenshot and the area screenshots, under guidance of the first guidance information.

4. The method according to claim 1, wherein an operation of based on the object information of the first object and the application information of the application where the first object is located before and after the location change event respectively, determining the processing intent for the first object, includes at least one of:
inputting the object information of the first object, the application information of the application where the first object is located before and after the location change event respectively, and second guidance information into the large language model, and obtaining a first processing intent for the first object, generated by the large language model under guidance of the secondary information; or
from an intent understanding dataset, determining a second processing intent matching the object information of the first object and the application information of the application where the first object is located before and after the location change event respectively,
wherein:
the processing intent for the first object includes at least one of the first processing intent or the second processing intent; and
the intent understanding dataset includes at least one piece of intent understanding data, wherein each piece of the at least one piece of intent understanding data includes an object information of a corresponding object, application information of an application where the corresponding object is located before and after a location change respectively, and a processing intent for the corresponding object.

5. The method according to claim 4, further comprising at least one of:
based on the object information of the first object, the application information of the application where the first object is located before and after the location change event respectively, and an actual processing intent for the first object, updating the intent understanding dataset; or
based on execution frequencies of different processing intents for objects in the intent understanding dataset, determining a weight of each processing intent of the different processing intents.

6. The method according to claim 1, wherein:
an operation of using the first intelligent agent to determine the target processing to be performed on the first object after the location change event, based on the confirmed result of processing intent, includes inputting the target intent and third guidance information into the large language model, and obtaining an operation sequence generated by the large language model under guidance of the third guidance information, to fulfill the target intent, wherein the operation sequence is configured to indicate one or more operations to be performed on the first object, and the target intent is an intent obtained based on the confirmed result of processing intent; and
an operation of using the second intelligent agent to perform the target processing on the first object after the location change event includes using a large action model to perform the one or more operations indicated by the operation sequence on the first object after the location change event.

7. The method according to claim 6, wherein a process of obtaining the target intent includes:
when the confirmed result of processing intent indicates that the processing intent for the first object is a single intent, obtaining the single intent or obtaining a first intent input by an operator, wherein the target intent is the single intent or the first intent; and
when the confirmed result of processing intent indicates that the processing intent for the first object includes a plurality of processing intents, obtaining an intent selected from the plurality of processing intents, or obtaining a second intent input by the operator, wherein the target intent is the intent selected from the plurality of processing intents, or the second intent.

8. The method according to claim 1, before detecting the location change event for the first object, further comprising:
in response to detecting an event of positioning a target control unit in an application in a target mode, identifying a second object located in an area corresponding to a location where the target control unit is positioned and obtaining an identification result, and controlling the second object to be in a target state based on the identification result,
wherein:
the target state refers to a state for selecting at least part of structural components of the second object; and
the first object refers to the at least part of the structural components of the second object selected from the second object.

9. The method according to claim 8, wherein an operation of controlling the second object to be in the target state based on the recognition result, includes:
when the recognition result indicates that the second object is text, controlling the second object to be in a first state that allows for selecting content of the text;
when the recognition result indicates that the second object is an image, controlling the second object to be in a second state that allows for capturing a screenshot of the image; and
when the recognition result indicates that the second object is an audio/video file, controlling the second object to be in a third state that allows for selecting a segment of the audio/video file.

10. An electronic device comprising:
one or more processors and a memory that contains computer instructions that, when being executed causes the one or more processors to perform:
in response to detecting a location change event for a first object, using a first intelligent agent to identify object information of the first object and application information of an application where the first object is located before and after the location change event respectively;
based on the object information of the first object and the application information of the application where the first object is located before and after the location change event respectively, determining a processing intent for the first object, and obtaining a confirmed result of processing intent;
using the first intelligent agent to determine target processing to be performed on the first object after the location change event, based on the confirmed result of processing intent; and
using a second intelligent agent to perform the target processing on the first object after the location change event, to obtain a processing result of the first object.

11. The electronic device according to claim 10, wherein the one or more processors are further configured to perform at least one of:
detecting a location change of dragging the first object from a first location to a second location in the application where the first object is located; or
detecting a location change of dragging an object in a first application to a second application.

12. The electronic device according to claim 10, wherein the one or more processors are further configured to perform:
obtaining an object screenshot of the first object, and area screenshots of areas where the first object is located before and after the location change event respectively; and
inputting the object screenshot, the area screenshots, and first guidance information into a large language model, and obtaining the object information of the first object and the application information of the application where the first object is located before and after the location change event respectively, generated by the large language model based on the object screenshot and the area screenshots, under guidance of the first guidance information.

13. The electronic device according to claim 10, wherein the one or more processors are further configured to perform at least one of:
inputting the object information of the first object, the application information of the application where the first object is located before and after the location change event respectively, and second guidance information into the large language model, and obtaining a first processing intent for the first object, generated by the large language model under guidance of the secondary information; or
from an intent understanding dataset, determining a second processing intent matching the object information of the first object and the application information of the application where the first object is located before and after the location change event respectively,
wherein:
the processing intent for the first object includes at least one of the first processing intent or the second processing intent; and
the intent understanding dataset includes at least one piece of intent understanding data, wherein each piece of the at least one piece of intent understanding data includes an object information of a corresponding object, application information of an application where the corresponding object is located before and after a location change respectively, and a processing intent for the corresponding object.

14. The electronic device according to claim 13, wherein the one or more processors are further configured to perform at least one of:
based on the object information of the first object, the application information of the application where the first object is located before and after the location change event respectively, and an actual processing intent for the first object, updating the intent understanding dataset; or
based on execution frequencies of different processing intents for objects in the intent understanding dataset, determining a weight of each processing intent of the different processing intents.

15. The electronic device according to claim 10, wherein:
an operation of using the first intelligent agent to determine the target processing to be performed on the first object after the location change event, based on the confirmed result of processing intent, includes inputting the target intent and third guidance information into the large language model, and obtaining an operation sequence generated by the large language model under guidance of the third guidance information, to fulfill the target intent, wherein the operation sequence is configured to indicate one or more operations to be performed on the first object, and the target intent is an intent obtained based on the confirmed result of processing intent; and
an operation of using the second intelligent agent to perform the target processing on the first object after the location change event includes using a large action model to perform the one or more operations indicated by the operation sequence on the first object after the location change event.

16. The electronic device according to claim 15, wherein the one or more processors are further configured to perform:
when the confirmed result of processing intent indicates that the processing intent for the first object is a single intent, obtaining the single intent or obtaining a first intent input by an operator, wherein the target intent is the single intent or the first intent; and
when the confirmed result of processing intent indicates that the processing intent for the first object includes a plurality of processing intents, obtaining an intent selected from the plurality of processing intents, or obtaining a second intent input by the operator, wherein the target intent is the intent selected from the plurality of processing intents, or the second intent.

17. The electronic device according to claim 10, wherein the one or more processors are further configured to perform:
in response to detecting an event of positioning a target control unit in an application in a target mode, identifying a second object located in an area corresponding to a location where the target control unit is positioned and obtaining an identification result, and controlling the second object to be in a target state based on the identification result,
wherein:
the target state refers to a state for selecting at least part of structural components of the second object; and
the first object refers to the at least part of the structural components of the second object selected from the second object.

18. The electronic device according to claim 17, wherein the one or more processors are further configured to perform:
when the recognition result indicates that the second object is text, controlling the second object to be in a first state that allows for selecting content of the text;
when the recognition result indicates that the second object is an image, controlling the second object to be in a second state that allows for capturing a screenshot of the image; and
when the recognition result indicates that the second object is an audio/video file, controlling the second object to be in a third state that allows for selecting a segment of the audio/video file.

19. A non-transitory computer readable storage medium containing computer instructions that, when being executed causes at least one processor to perform:
in response to detecting a location change event for a first object, using a first intelligent agent to identify object information of the first object and application information of an application where the first object is located before and after the location change event respectively;
based on the object information of the first object and the application information of the application where the first object is located before and after the location change event respectively, determining a processing intent for the first object, and obtaining a confirmed result of processing intent;
using the first intelligent agent to determine target processing to be performed on the first object after the location change event, based on the confirmed result of processing intent; and
using a second intelligent agent to perform the target processing on the first object after the location change event, to obtain a processing result of the first object.

20. The storage medium according to claim 19, wherein the at least one processor is further configured to perform at least one of:
detecting a location change of dragging the first object from a first location to a second location in the application where the first object is located; or
detecting a location change of dragging an object in a first application to a second application.
